(19) United States
(12) Patent Application Publication
(10) Pub. No.: US 2002/0080870 A1
(43) Pub. Date: Jun. 27, 2002

(54) METHOD AND APPARATUS FOR PERFORMING MOTION COMPENSATION IN A TEXTURE MAPPING ENGINE

(76) Inventors: THOMAS A. PIAZZA, GRANITE BAY, CA (US); VAL G. COOK, SHINGLE SPRINGS, CA (US)

Correspondence Address: PAUL A MENDONSA, BLAKELY SOKOLOFF TAYLOR AND ZAFMAN, 12400 WILSHIRE BOULEVARD, 7TH FLOOR, LOS ANGELES, CA, 90025

(21) Appl. No.: 09/227,174

(22) Filed: Jan. 7, 1999

(51) Int. Cl. H04B 1/66

(52) U.S. Cl. 375/240

(57) ABSTRACT

A method and apparatus for motion compensation of digital video data with a texture mapping engine is described. In general, the invention provides motion compensation by reconstructing a picture by predicting pixel colors from one or more reference pictures. The prediction can be forward, backward or bidirectional. The architecture described herein provides for reuse of texture mapping hardware components to accomplish motion compensation of digital video data. Bounding boxes and edge tests are modified such that complete macroblocks are processed for motion compensation. In addition, pixel data is written into a texture palette according to a first order based on Inverse Discrete Cosine Transform (IDCT) results and read out according to a second order optimized for locality of reference. A texture palette memory management scheme is provided to maintain current data and avoid overwriting of valid data when motion compensation commands are pipelined.

### FIELD OF THE INVENTION

The invention relates to graphics display by electronic devices. More particularly, the invention relates to motion compensation of graphics that are displayed by electronic devices.

### BACKGROUND OF THE INVENTION

Several standards currently exist for communication of digital audio and/or video data. For example, the Motion Picture Experts Group (MPEG) has developed several standards for use with audio-video data (e.g., MPEG-1, MPEG-2, MPEG-4). In order to improve data communications audio-video data standards often include compression schemes. In particular, MPEG-2 provides use of a motion vector as part of a digital video compression scheme.

In general, motion vectors are used to reduce the amount of data required to communicate full motion video by utilizing redundancy between video frames. The difference between frames can be communicated rather than the consecutive full frames having redundant data. Typically, motion vectors are determined for 16×16 pixel (pel) sets of data referred to as a “macroblock.”

Digital encoding using motion compensation uses a search window or other reference that is larger than a macroblock to generate a motion vector pointing to a macroblock that best matches the current macroblock. The search window is typically larger than the current macroblock. The resulting motion vector is encoded with data describing the macroblock.

Decoding of video data is typically accomplished with a combination of hardware and software. Motion compensation is typically decoded with dedicated motion compensation circuitry that operates on a buffer of video data representing a macroblock. However, this scheme results in the motion compensation circuitry being idle when a video frame is processed by a texture mapping engine and the texture mapping engine is idle when the video frame is processed by the motion compensation circuitry. This sequential decoding of video data results in inefficient use of decoding resources. What is needed is an improved motion compensation decoding scheme.

### SUMMARY OF THE INVENTION

A method and apparatus for motion compensation of graphics with a texture mapping engine is described. A command having motion compensation data related to a macroblock is received. Decoding operations for the macroblock that generate correction data are performed. The correction data is stored in a texture palette according to a first order that corresponds to an output of the decoding operations. Frame prediction operations are performed in response to the command. The correction data is read from the texture palette according to a second order. The correction data is combined with results from the frame prediction operations to generate an output video frame.

### BRIEF DESCRIPTION OF THE DRAWINGS

The invention is illustrated by way of example, and not by way of limitation in the figures of the accompanying drawings in which like reference numerals refer to similar elements.

FIG. 1 is a system suitable for use with the invention.

FIG. 2 is a block diagram of an MPEG-2 decoding process suitable for use with the invention.

FIG. 3 is a typical timeline of frame delivery and display of MPEG-2 frames.

FIG. 4 illustrates three MPEG-2 frames.

FIG. 5 illustrates a conceptual representation of pixel data suitable for use with the invention.

FIG. 6 is a block diagram of components for performing motion compensation and texture mapping according to one embodiment of the invention.

FIG. 7 illustrates luminance correction data for a 16 pixel by 16 pixel macroblock.

FIG. 8 is a block diagram of a hardware-software interface for motion compensation decoding according to one embodiment of the invention.

### DETAILED DESCRIPTION

A method and apparatus for motion compensation of graphics with a texture mapping engine is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In general, the invention provides motion compensation by reconstructing a picture by predicting pixel colors from one or more reference pictures. The prediction can be forward, backward or bi-directional. The architecture described herein provides for reuse of texture mapping hardware components to accomplish motion compensation of digital video data. Bounding boxes and edge tests are modified such that complete macroblocks are processed for motion compensation. In addition, pixel data is written into a texture palette according to a first order based on Inverse Discrete Cosine Transform (IDCT) results and read out according to a second order optimized for locality of reference. A texture palette memory management scheme is provided to maintain current data and avoid overwriting of valid data when motion compensation commands are pipelined.

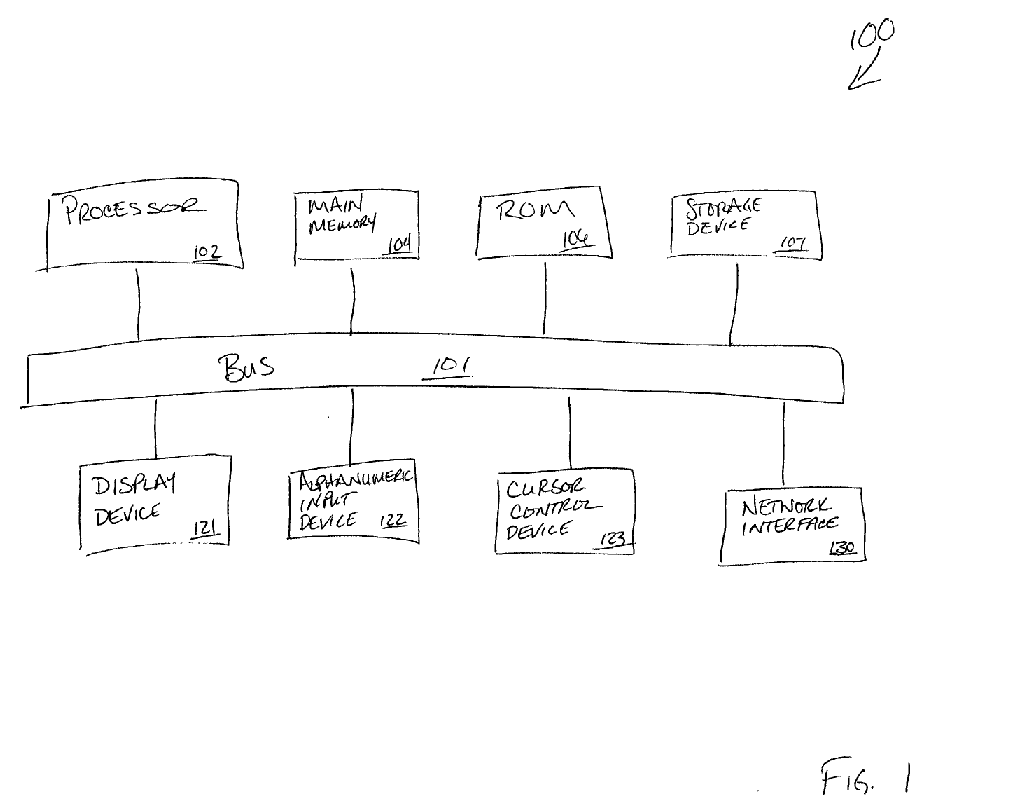

FIG. 1 is one embodiment of a system suitable for use with the invention. System 100 includes bus 101 or other communication device for communicating information and processor 102 coupled to bus 101 for processing information. System 100 further includes random access memory (RAM) or other dynamic storage device 104 (referred to as main memory), coupled to bus 101 for storing information and instructions to be executed by processor 102. Main memory 104 also can be used for storing temporary variables or other intermediate information during execution of instructions by processor 102. System 100 also includes read only memory (ROM) and/or other static storage device 106 coupled to bus 101 for storing static information and instructions for processor 102. Data storage device 107 is coupled to bus 101 for storing information and instructions.

Data storage device 107 such as a magnetic disk or optical disc and corresponding drive can be coupled to system 100. System 100 can also be coupled via bus 101 to display device 121, such as a cathode ray tube (CRT) or liquid crystal display (LCD), for displaying information to a computer user as well as supporting circuitry. Digital video decoding and processing circuitry is described in greater detail below. Alphanumeric input device 122, including alphanumeric and other keys, is typically coupled to bus 101 for communicating information and command selections to processor 102. Another type of user input device is cursor control 123, such as a mouse, a trackball, or cursor direction keys for communicating direction information and command selections to processor 102 and for controlling cursor movement on display 121.

Network interface 130 provides an interface between system 100 and a network (not shown in FIG. 1). Network interface 130 can be used, for example, to provide access to a local area network, or to the Internet. Network interface 130 can be used to receive digital video data from a remote source for display by display device 121.

One embodiment of the present invention is related to the use of system 100 to perform motion compensation in a graphics texture mapping engine. According to one embodiment, motion compensation is performed by system 100 in response to processor 102 executing sequences of instructions contained in main memory 104.

Instructions are provided to main memory 104 from a storage device, such as magnetic disk, a read-only memory (ROM) integrated circuit (IC), CD-ROM, DVD, via a remote connection (e.g., over a network), etc. In alternative embodiments, hard-wired circuitry can be used in place of or in combination with software instructions to implement the present invention. Thus, the present invention is not limited to any specific combination of hardware circuitry and software instructions.

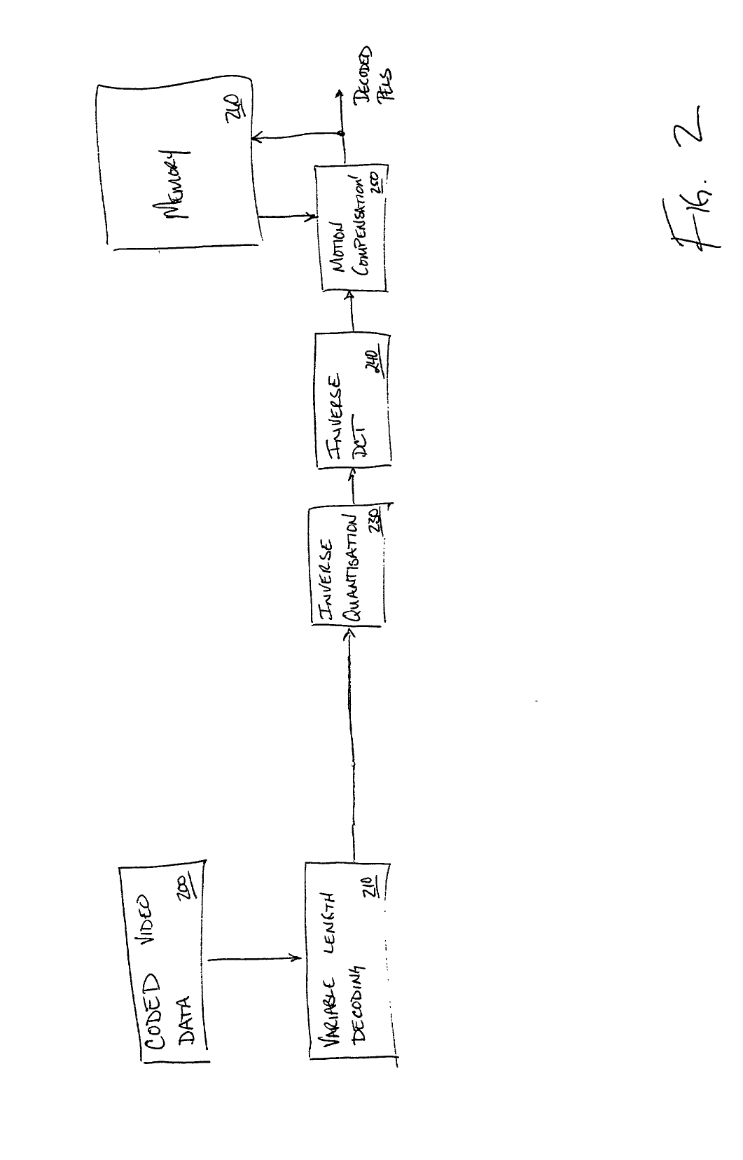

FIG. 2 is a block diagram of an MPEG-2 decoding process suitable for use with the invention. Decoded video data 200 is obtained. Decoded video data 200 can come from either a local (e.g., memory, DVD, CD-ROM) or a remote (e.g., Web server, video conferencing system) source.

In one embodiment, coded video data 200 is encoded using variable length codes. In such an embodiment, an input bit stream is decoded and converted into a two-dimensional array via variable length decoding 210. Variable length decoding 210 operates to identify instructions in the input stream having variable lengths because of, for example, varying amounts of data, varying instruction sized, etc.

The output of variable length decoding 210 provides input to inverse quantization 230, which generates a set of Discrete Cosine Transform (DCT) coefficients. The two-dimensional array of DCT coefficients is processed via inverse DCT (IDCT) 240, which generates a two-dimensional array of correction data values. The correction data values include motion vectors for video data. In one embodiment the correction data values include luminance and chrominance as well as motion vectors.

Correction data values from IDCT 240 are input to motion compensation block 250, which results in decoded pels. The decoded pels and the correction data values are used to access pixel value data stored in memory 260. Memory 260 stores predicted pixels and reference pixels.

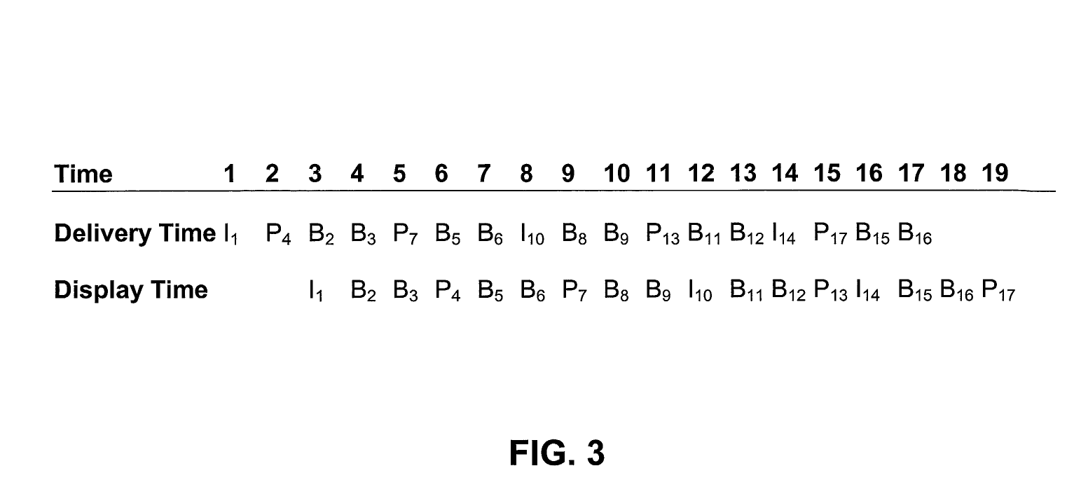

FIG. 3 is a typical timeline of frame delivery and display of MPEG-2 frames. Frames within a video stream can be decoded in a different order than display order. In addition frames can be delivered in a different order than shown in FIG. 3. Ordering of frame delivery can be chosen based on several factors as is well known in the art.

Video frames are categorized as Intra-coded (1), Predictive-coded (P), Bi-directionally predictive-coded (B). Intra-coded frames are frames that are not reconstructed from other frames. In other words, the compete frame is communicated rather than differences between previous and/or subsequent frames.

Bi-directionally predictive coded frames are interpolated from both a preceding and a subsequent frame based on differences between the frames. B frames can also be predicted from forward or backward reference frames. Predictive coded frames are interpolated from a forward reference picture. Use of I, P and B frames is known in the art and not described in further detail except as it pertains to the invention. The subscripts in FIG. 3 refer to the original ordering of frames as received by an encoder. Use of I, P and B frames with the invention is described in greater detail below.

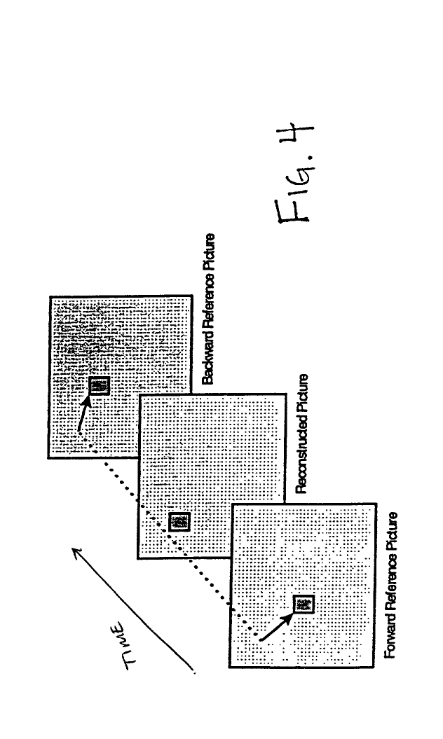

FIG. 4 illustrates three MPEG-2 frames. The reconstructed picture is a currently displayed B or P frame. The forward reference picture is a frame that is backwards in time as compared to the reconstructed picture. The backward reference picture is a frame that is forward in time as compared to the reconstructed picture.

Frames are either reconstructed with either a “Frame Picture Structure” or a “Field Picture Structure.” A frame picture contains every scan line of the image, while a field picture contains only alternate scan lines. The “Top field” contains the even numbered scan lines and the “Bottom field” contains odd numbered scan lines. Frame picture structures and field picture structures as related to motion vectors are described in greater detail below. In one embodiment, the Top field and the Bottom field are stored in memory in an interleaved manner. Alternatively, the Top and Bottom fields can be stored independently of each other.

In general, motion compensation consists of reconstruction a picture by predicting, either forward, backward or bi-directionally, the resulting pixel colors from one or more reference pictures. FIG. 4 illustrates two reference pictures and a bi-directionally predicted reconstructed picture. In one embodiment, the pictures are divided into 16 pixel by 16 pixel macroblocks; however, other macroblock sizes (e.g., 16×8, 8×8) can also be used. A macroblock is further divided into 8 pixel by 8 pixel blocks.

In one embodiment, motion vectors originate at the upper left corner of a current macroblock and point to an offset location where the most closely matching reference pixels are located. Motion vectors can originate from other locations within a macroblock and can be used for smaller portions of a macroblock. The pixels at the locations indicated by the motion vectors are used to predict the reconstructed picture.

In one embodiment, each pixel in the reconstructed picture is bilinearly filtered based on pixels in the reference picture(s). The filtered color from the reference picture(s) is interpolated to form a new color. A correction term based on the IDCT output can be added to further refine the prediction of the resulting pixels.

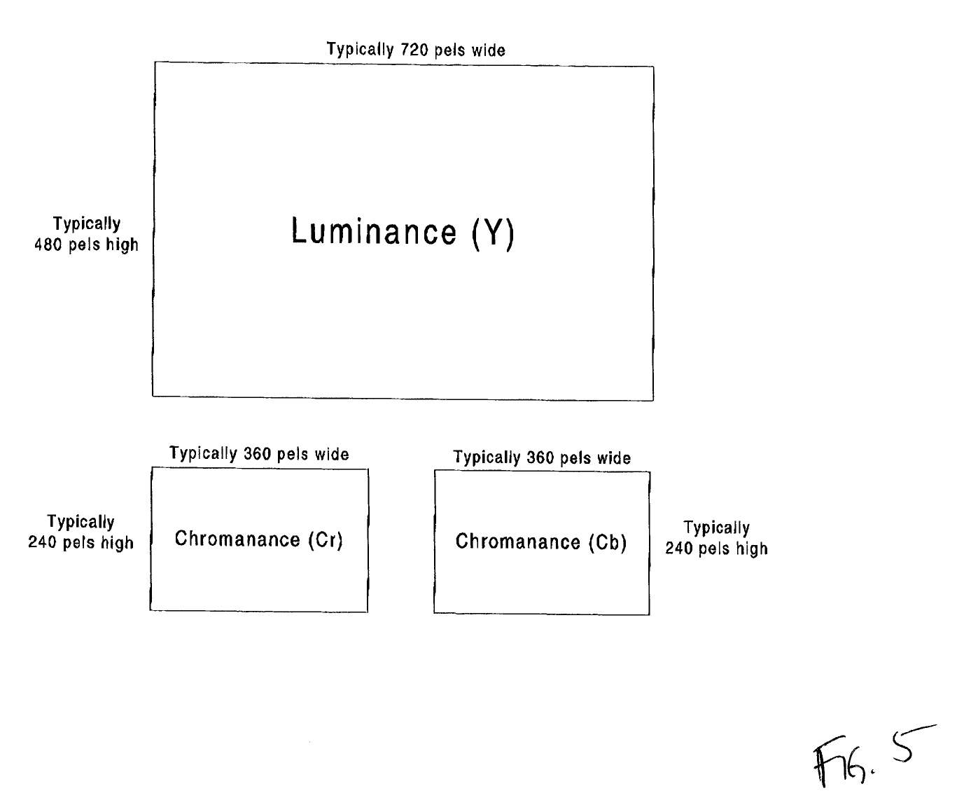

FIG. 5 illustrates a conceptual representation of pixel data suitable for use with the invention. Each macroblock has 256 bytes of luminance (Y) data for the 256 pixels of the macroblock. The blue chromance (U) and red chromance (V) data for the pixels of the macroblock are communicated at ¼resolution, or 64 bytes of U data and 64 byes of V data for the macroblock and filtering is used to blend pixel colors. Other pixel encoding schemes can also be used.

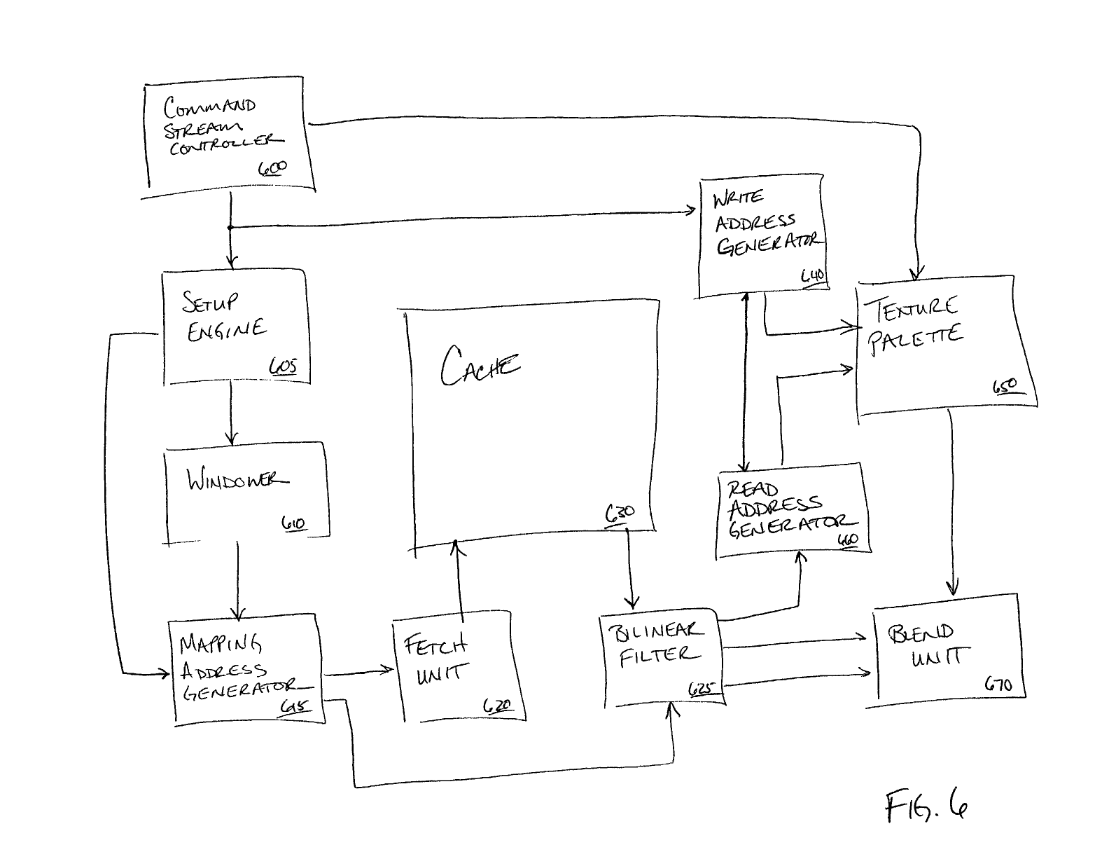

FIG. 6 is a block diagram of components for performing motion compensation and texture mapping according to one embodiment of the invention. The components of FIG. 6 can be used to perform both texture mapping and motion compensation. In one embodiment, motion compensation decoding is performed in response to a particular command referred to herein as the GFXBLOCK command; however, other command names and formats can also be used. One format for the GFXBLOCK command is described in greater detail below with respect to FIG. 9.

Command stream controller 600 is coupled to receive commands from an external source, for example, a processor or a buffer. Command stream controller 600 parses and decodes the commands to perform appropriate control functions. If the command received is not a GFXBLOCK command, command stream controller 600 passes control signals and data to setup engine 605. Command stream controller 600 also controls memory management, state variable management, two-dimensional operations, etc. for non-GFXBLOCK commands.

In one embodiment, when command stream controller receives a GFXBLOCK command, correction data is forwarded to and stored in texture palette 650; however, correction data can be stored in any memory. Command stream controller 600 also sends control information to write address generator 640. The control information sent to write address generator 640 includes block pattern bits, prediction type (e.g., I, B or P), etc. Write address generator 640 causes the correction data for pixels of a macroblock to be written into texture palette in an order as output by an IDCT operation for the macroblock. In one embodiment the IDCT operation is performed in software; however, a hardware implementation can also be used.

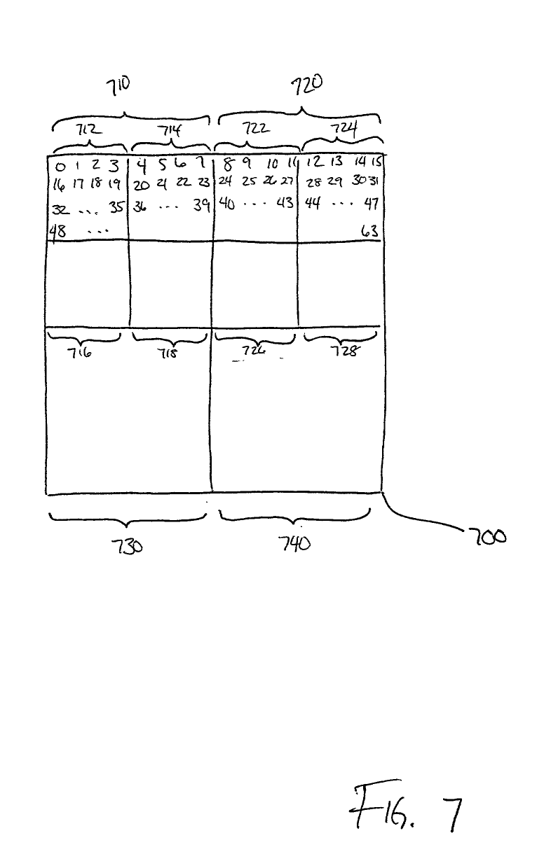

FIG. 7 illustrates luminance correction data for a 16 pixel by 16 pixel macroblock. Generally, macroblock 700 includes four 8 pixel by 8 pixel blocks labeled 710, 720, 730 and 740. Each block includes four 4 pixel by 4 pixel sub-blocks. For example, block 710 includes sub-blocks 712, 714, 716 and 718 and block 720 includes sub-blocks 722, 724, 726 and 728.

Write address generator 640 causes correction data for the pixels of a macroblock to be written to texture palette 650 block by block in row major order. In other words, the first row of block 710 (pixels 0-7) is written to texture palette 650 followed by the second row of block 710 (pixels 16-23). The remaining rows of block 710 are written to texture palette 650 in a similar manner.

After the data from block 710 is written to texture palette 650, data from block 720 is written to texture palette 650 in a similar manner. Thus, the first row of block 720 (pixels 8-15) are written to texture palette 650 followed by the second row of block 720 (pixels 24-31). The remaining rows of block 720 are written to texture palette 650 in a similar manner. Blocks 730 and 740 are written to texture palette 650 in a similar manner.

Referring back to FIG. 6, command stream controller 600 also sends control information to setup engine 605. In one embodiment, command stream controller 600 provides setup engine 605 with co-ordinates for the origin of the macroblock corresponding to the GFXBLOCK command being processed. For example, the co-ordinates (0,0) are provided for the top left macroblock of a frame, or the co-ordinates (0,16) are provided for the second macroblock of the top row of a frame.

Command stream controller 600 also provides setup engine 605 with height and width information related to the macroblock. From the information provided, setup engine 605 determines a bounding box that is contained within a predetermined triangle in the macroblock. In contrast, when texture mapping is being performed, setup engine 605 determines a bounding box that contains the triangle. Thus, when motion compensation is being performed, the entire macroblock is iterated rather than only the triangle.

In one embodiment, the bonding box is defined by the upper left and lower right comers of the bounding box. The upper left of the bounding box is the origin of the macroblock included in the GFXBLOCK command. The lower right corner of the bounding box is computer by adding the region height and width to the origin.

In one embodiment, the bonding box computes a texture address offset, P_{O}, which is determined according to:

P_{Ou}=Originₓ+MVₓ (Equation 1)

and

P_{Or}=Origin_{y}+MV_{y} (Equation 2)

where P_{Ov} and P_{Ou} are offsets for v and u co-ordinates, respectively. Originₓ and Origin_{y} are the x and y co-ordinates of the bounding box origin, respectively, and MVₓ and MV_{y} are the x and y components of the motion vector, respectively. The P_{O} term translates the texture addresses in a linear fashion.

In one embodiment P_{Ov} and P_{Ou} are computed vectorially by summing the motion vectors with the region origin according to:

$$\begin{matrix}u ( x , y ) = \frac{{C}_{xS} \cdot x + {C}_{yX} \cdot y + {C}_{0 S}}{{C}_{xiW} \cdot x + {C}_{yiW} \cdot {C}_{0 iW}} + {P}_{0 u} \\ and & ( Equation 3 ) \\ v ( x , y ) = \frac{{C}_{xT} \cdot x + {C}_{yT} \cdot y + {C}_{0 T}}{{C}_{xiW} \cdot x + {C}_{yiW} \cdot y + {C}_{0 iW}} + {P}_{0 v} & ( Equation 4 )\end{matrix}$$

where the variables in Equations 3 and 4 are as described below. In one embodiment, the values below are used for GFXBLOCK commands. For non-GFXBLOCK commands the values are calculated by setup engine 605. By using the values below, complex texture mapping equations can be simplified for use for motion compensation calculations, thereby allowing hardware to be used for both purposes.

| Variable | Description | Value |
|---|---|---|
| C_{xS} | Rate of change of S with respect to x | 1.0 |
| C_{OS} | Offset to S | 0.0 |
| C_{yS} | Rate of change of S with respect to y | 0.0 |
| C_{xT} | Rate of change of T with respect to x | 0.0 |
| C_{OS} | Offset to T | 0.0 |
| C_{yT} | Rate of change of T with respect to y | 1.0 |
| C_{xiW} | Rate of change of 1/W with respect to x | 0.0 |
| C_{OiW} | Offset to 1/W | 1.0 |
| C_{yiW} | Rate of change of 1/W with respect to y | 0.0 |

The u, v texture addresses are used to determine which pixels are fetched from reference pixels.

Mapping address generator 615 provides read addresses to fetch unit 620. The read address generated by mapping address generator 615 and provided to fetch unit 620 are based on pixel movement between frames as described by the motion vector. This allows pixels stored in memory to be reused for a subsequent frame by rearranging the addresses of the pixels fetched. In one embodiment, the addresses generated by mapping address generator 615 using the values listed abvoe simplify to:

v(x,y)=y+P_{Ov} (Equation 5)

and

u(x,y)=x+P_{Ou} (Equation 6)

Setup engine 605 provides the bounding box information to windower 610. Windower 610 iterates the pixels within the bounding box to generate write address for data written by the GFXBLOCK command. In other words, the triangle edge equations are always passed, which allows windower 610 to process the entire macroblock rather than stopping at a triangle boundary.

Windower 610 generates pixel write addresses to write data to a cache memory not shown in FIG. 6. Windower 610 also provides mapping address generator 615 with the origin of the macroblock and motion vector information is provided to mapping address generator 615. In one embodiment, windower 610 provides a steering command and a pixel mask to mapping address generator 615, which determines reference pixel locations based on the information provided by windower 610 and setup engine 605.

Fetch unit 620 converts the read addresses provided by mapping address generator 615 to cache addresses. The cache addresses generated by fetch unit 620 are sent to cache 630. The pixel data stored at the cache address is sent to bilinear filter 625. Mapping address generator 615 sends fractional-pixel positioning data and cache addresses for neighboring pixels to bilinear filter 615. If the motion vector defines a movement that is less than a full pixel, bilinear filter 625 filters the pixel data returned from cache 630 based on the fractional position data and the neighboring pixels. Bilinear filtering techniques are well known in the art and not discussed further herein.

In one embodiment, bilinear filter 625 generates both forward and backward filtered pixel information that is sent to blend unit 670. This information can be sent to blend unit 670 using separate channels as shown in FIG. 6, or the information can be time multiplexed over a single channel. Bilinear filter 625 sends pixel location information to read address generator 660. The pixel location information is positioning and filtering as described above.

Read address generator 660 causes pixel information to be read from texture palette 650 in an order different than written as controlled by write address generator 640. Referring to FIG. 7, read address generator 660 causes pixel data to be read from texture palette 650 sub-block-by-sub-block in row major order. This ordering optimizes performance of cache 630 due to locality of reference of pixels stored therein. In other words, the first row of sub-block 712 (pixels 0-3) are read followed by the second row of sub-block 712 (pixels 16-19). The remaining pixels of sub-block 712 are read in a similar manner.

After the pixels of sub-block 712 are read the pixels of sub-block 714 are read in a similar manner. The first row of sub-block 714 (pixels 4-7) are read followed by the second row of sub-block 714 (pixels 20-23). The remaining sub-blocks of block 710 (716 and 718) are read in a similar manner. The sub-blocks of block 720 are read in a similar manner followed by the sub-blocks of block 730 and finally by the sub-blocks of block 740.

The pixels read from texture palette 650 are input to blend unit 670. Blend unit 670 combines the pixel data from bilinear filter 625 with correction data from texture palette to generate an output pixel for a new video frame. Mapping address generator 615 provides fractional pixel positioning information to bilinear filter 625.

Multiple GFXBLOCK commands can exist in the pipeline of FIG. 6 simultaneously. As a result correction data steams through texture palette 650. Read and write accesses to texture palette 650 are managed such that the correction data steams do not overwrite valid data stored in the texture palette 650.

In one embodiment, a FIFO buffer (not shown in FIG. 6) is provided between mapping address generator 615 and bilinear filter 625. Because memory accesses are slower than other hardware operations, accesses to memory storing reference pixels can stall pipelined operations. The FIFO buffer allows memory latency to be hidden, which allows the pipeline to function without waiting for reference pixels to be returned from the memory, thereby improving pipeline performance.

In order to concurrently hide memory latency and store correction data in texture palette 650 for subsequent GFXBLOCK commands, write address generator 640 is prevented from overwriting valid data in texture palette 650. In one embodiment, read address generator 660 communicates synch points to write address generator 640. The synch points correspond to addresses beyond which read access generator 660 will not access. Similarly, write address generator 640 communicates synch points to read address generator 660 to indicate valid data.

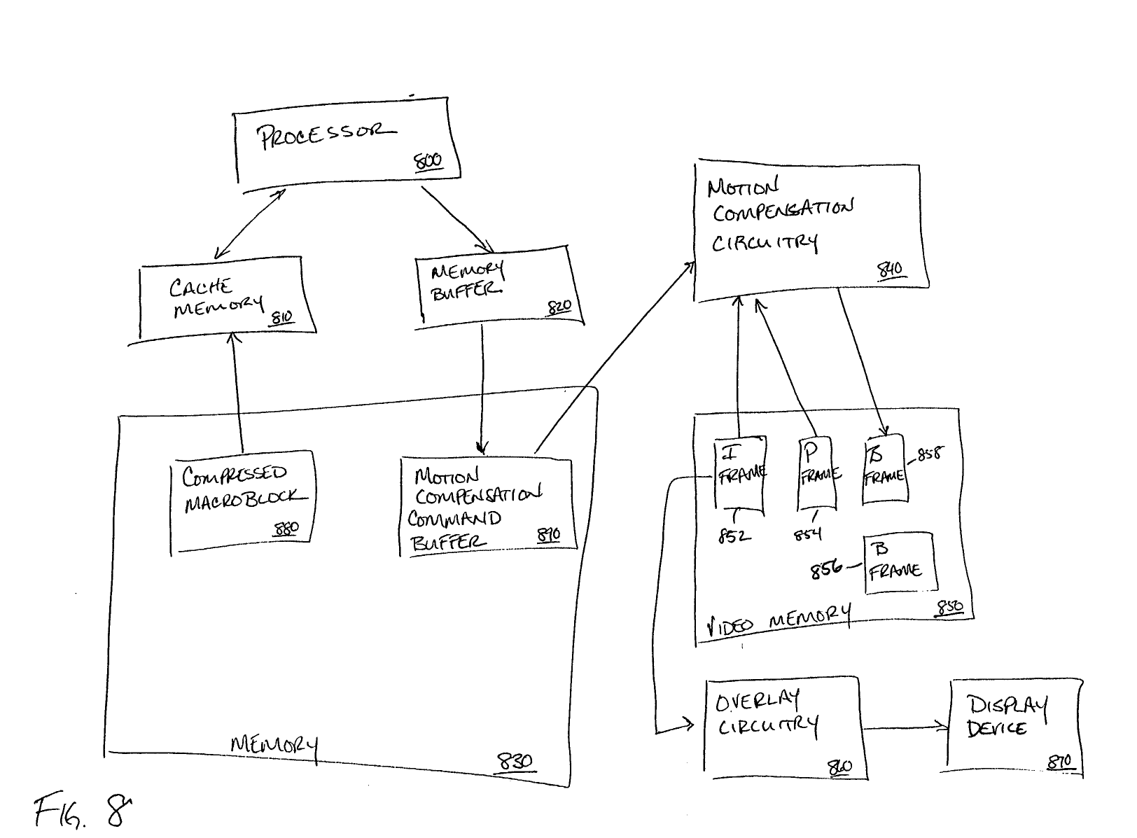

FIG. 8 is a block diagram of a hardware-software interface for motion compensation decoding according to one embodiment of the invention. The block diagram of FIG. 8 corresponds to a time at which the motion compensation circuitry is rendering a B frame and an I frame is being displayed. Certain input and/or output frames may differ as a video stream is processed.

Compressed macroblock 880 is stored in memory 830. In one embodiment, memory 830 is included within a computer system, or other electronic device. Compressed macroblock 880 can also be obtained from sources such as, for example, a CD-ROM, DVD player, etc.

In one embodiment, compressed macroblock 880 is stored in cache memory 810. Storing compressed macroblock 880 in cache memory 810 gives processor 800 faster access to the data in compressed macroblock 880. In alternative embodiments, compressed macroblock 880 is accessed by processor 800 in memory 830.

Processor 800 processes macroblock data stored in cache memory 810 to parse and interpret macroblock commands. In one embodiment, processor 800 also executes a sequence of instructions to perform one or more IDCT operations on macroblock data stored in cache memory 810. Processor 800 stores the results of the IDCT operations and command data in memory buffer 820. Memory buffer 820 stages data to be stored in memory 830.

Data from memory buffer 820 is stored in motion compensation command buffer 890. In one embodiment, motion compensation command buffer 890 is a FIFO queue that stores motion compensation commands, such as the GFXBLOCK command prior to processing by motion compensation circuitry 840. Motion compensation circuitry 840 operates on motion compensation commands as described above with respect to FIG. 6.

In the example of FIG. 8, motion compensation circuitry 840 reconstructs B frame 858 from I frame 852 and P frame 854. In one embodiment, the various frames are stored in video memory 850. Alternatively, the frames can be stored in memory 830 or some other memory. If, for example, motion compensation circuitry 840 were rendering a B frame a single frame would be read from video memory 850 for reconstruction purposes. In the example of FIG. 8, four frames are stored in video memory 850; however, any number of frames can be stored in video memory 850.

The frame being displayed (I frame 852) is read from video memory 850 by overlay circuitry 860. Overlay circuitry 860 converts YUV encoded frames to red-green-blue (RGB) encoded frames so that the frames can be displayed by display device 870. Overlay circuitry 860 can convert the displayed frames to other formats if necessary.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method of motion compensation of digital video data, the method comprising:
receiving a motion compensation command having associated correction data related to a macroblock;
storing the correction data in a memory according to a first order corresponding to the motion compensation command;
performing frame prediction operations in response to the motion compensation command;
reading the correction data from the memory according to a second order; and
combining the correction data with results from the frame prediction operations to generate an output video frame.

2. The method of claim 1 the first order is based on output from an Inverse Discrete Cosine Transform (IDCT) operation.

3. The method of claim 1 performing frame prediction operations further comprises:
generating a bounding box containing the macroblock; and
iterating the bounding box;
fetching reference pixels;
filtering the reference pixels;
averaging the filtered reference pixels, if necessary; and
adding correction data to the reference pixels.

4. The method of claim 1 wherein the motion compensation data includes at least one motion vector.

5. The method of claim 1 further comprising performing texturing operations for the macroblock.

6. An apparatus for motion compensation of digital video data, the apparatus comprising:
means for receiving a motion compensation command having associated correction data related to a macroblock;
means for storing the correction data in a memory according to a first order corresponding to the motion compensation command;
means for performing frame prediction operations in response to the motion compensation command;
means for reading the correction data from the memory according to a second order; and
means for combining the correction data with results from the frame prediction operations to generate an output video frame.

7. The apparatus of claim 6 the first order is based on output from an Inverse Discrete Cosine Transform (IDCT) operation.

8. The apparatus of claim 6 performing frame prediction operations further comprises:
means for generating a bounding box containing the macroblock; and
means for iterating the bounding box;
means for fetching reference pixels;
means for filtering the reference pixels;
means for averaging the filtered reference pixels, if necessary; and
means for adding correction data to the reference pixels.

9. The apparatus of claim 6 wherein the motion compensation data includes at least one motion vector.

10. The apparatus of claim 6 further comprising means for performing texturing operations for the macroblock.

11. A circuit for generating motion compensated video, the circuit comprising:
a command stream controller coupled to receive an instruction to manipulate motion compensated video data;
a write address generator coupled to the command stream controller;
a memory coupled to the command stream controller and to the write address generator, the texture palette to store pixel data in a first order determined by the write address generator;
processing circuitry coupled to the write address generator to receive control information and data from the command stream controller to generate a reconstructed video frame;
a read address generator coupled to the processing circuitry and to the memory, the read address generator to cause the memory to output pixel data in a second order.

12. The circuit of claim 11 wherein the first order is block-by-block row major order.

13. The circuit of claim 11 wherein the first order corresponds to an output sequence of an inverse discrete cosine transform operation.

14. The circuit of claim 11 wherein the second order is sub-block-by-sub- block row major order.

15. The circuit of claim 11 wherein the processing circuitry comprises a setup engine that determines a bounding box for pixels manipulated by the instruction, wherein the bounding box contains all edges of a macroblock.

16. The circuit of claim 11 wherein the processing circuitry comprises a windower having a first mode wherein pixels inside a triangle within a bounding box are processed, and a second mode wherein all pixels within the bounding box are processed.
